(19) United States
(12) Patent Application Publication
(10) Pub. No.: US 2022/0343773 A1
(43) Pub. Date: Oct. 27, 2022

(54) UPDATING AIRSPACE AWARENESS FOR UNMANNED AERIAL VEHICLES

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 17/726,302

(22) Filed: Apr. 21, 2022

Related U.S. Application Data
(60) Provisional application No. 63/180,518, filed on Apr. 27, 2021.

(51) Int. Cl. G08G 5/00; B64C 39/02

(52) U.S. Cl. CPC G08G 5/0047; G08G 5/0017; G08G 5/003; B64C 39/024; B64C 2201/12

(57) ABSTRACT

Methods, apparatuses, system, devices, and computer program products for updating airspace awareness for unmanned aerial vehicles are disclosed. In a particular embodiment, the classification of a detected object is identified based on sensor data collected by an in-flight unmanned aerial vehicle (UAV). The location of the object is determined based on the sensor data. An airspace awareness controller generates, in dependence upon the classification of the object and the location of the object, an airspace awareness update concerning the object.

### CROSS-REFERENCE TO RELATED APPLICATIONS

This application is a non-provisional application for patent entitled to a filing date and claiming the benefit of earlier-filed U.S. Provisional Patent Application Ser. No. 63/180,518, filed Apr. 27, 2021, the contents of which are herein incorporated by reference in their entirety.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under 400 feet above ground level (AGL)) in airspace where FAA air traffic services are not provided. However, a framework that extends beyond the 400 feet AGL limit is needed. For example, unmanned aircraft that would be used by package delivery services and air taxis may need to travel at altitudes above 400 feet. Such a framework requires technology that will allow the FAA to safely regulate unmanned aircraft.

### SUMMARY

Methods, apparatuses, system, devices, and computer program products for updating airspace awareness for unmanned aerial vehicles are disclosed. In a particular embodiment, the classification of a detected object is identified based on sensor data collected by an in-flight unmanned aerial vehicle (UAV). The location of the object is determined based on the sensor data. A controller generates, in dependence upon the classification of the object and the location of the object, an airspace awareness update concerning the object.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating a particular implementation of a system for updating airspace awareness for unmanned aerial vehicles;

FIG. 2 sets forth a block diagram illustrating another implementation of a system for updating airspace awareness for unmanned aerial vehicles;

FIG. 3A sets forth a block diagram illustrating a particular implementation of the blockchain used by the systems of FIGS. 1-2 to record data associated with an unmanned aerial vehicle;

FIG. 3B sets forth an additional view of the blockchain of FIG. 3A;

FIG. 3C sets forth an additional view of the blockchain of FIG. 3A;

FIG. 4 sets forth a block diagram illustrating another implementation of a system for updating airspace awareness for unmanned aerial vehicles;

FIG. 5 is a flowchart to illustrate another implementation of a method for updating airspace awareness for unmanned aerial vehicles;

FIG. 6 is a flowchart to illustrate another implementation of a method for updating airspace awareness for unmanned aerial vehicles;

FIG. 7 is a flowchart to illustrate another implementation of a method for updating airspace awareness for unmanned aerial vehicles;

FIG. 8 is a flowchart to illustrate another implementation of a method for updating airspace awareness for unmanned aerial vehicles;

FIG. 9 is a flowchart to illustrate another implementation of a method for updating airspace awareness for unmanned aerial vehicles;

FIG. 10 is a flowchart to illustrate another implementation of a method for updating airspace awareness for unmanned aerial vehicles;

FIG. 11 is a flowchart to illustrate another implementation of a method for updating airspace awareness for unmanned aerial vehicles; and

FIG. 12 is a flowchart to illustrate another implementation of a method for updating airspace awareness for unmanned aerial vehicles.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

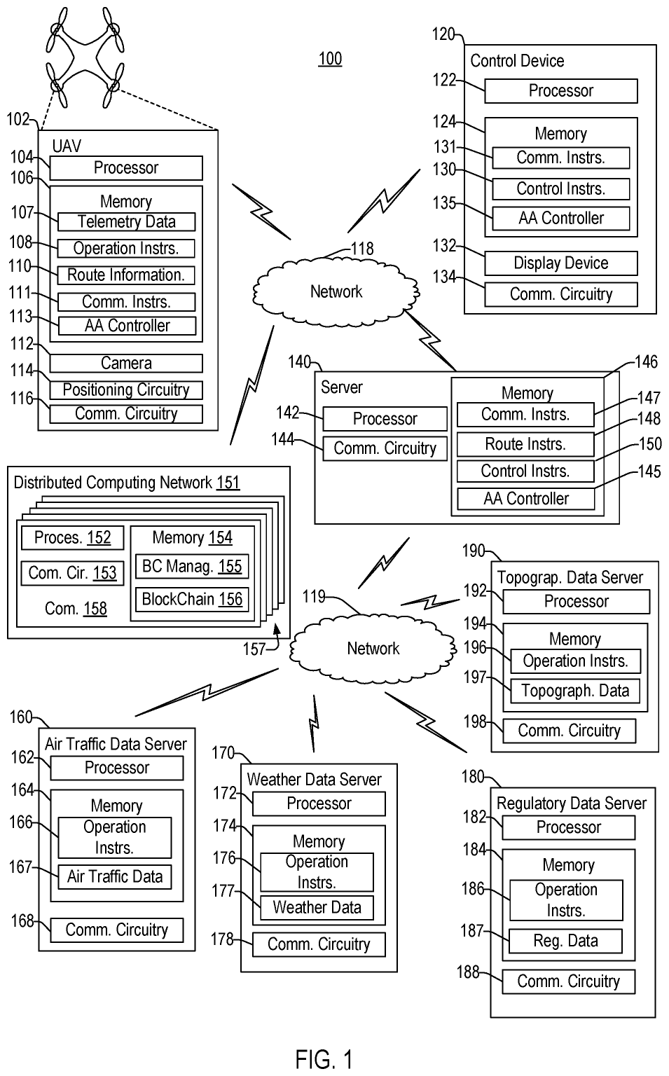

Exemplary methods, apparatuses, and computer program products for updating airspace awareness for unmanned aerial vehicles in accordance with the present invention are described with reference to the accompanying drawings, beginning with FIG. 1. FIG. 1 sets forth a diagram of a system 100 for unmanned aerial vehicle updating airspace awareness for unmanned aerial vehicles according to embodiments of the present disclosure. The system 100 of FIG. 1 includes an unmanned aerial vehicle (UAV) 102, a control device 120, a server 140, a distributed computing network 151, an air traffic data server 160, a weather data server 170, a regulatory data server 180, and a topographical data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones drone taxi, flying taxi, or pilotless helicopter carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the control device 120 or the server 140) that sent the incoming message(s). As will be explained further below, the outgoing and incoming messages may be transaction messages that include information associated with the UAV. Thus, in this implementation, communications between the UAV 102, the control device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more control devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point.

The route information 110 may also indicate a corresponding set of control devices for various points, zones, regions, areas of the flight path. The indicated sets of control devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

In the example of FIG. 1, the memory 106 of the UAV 102 also includes communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

In the example of FIG. 1, the memory 106 of the UAV 102 also includes airspace awareness controller 113 that when executed by the processor 104 cause the processor 104 to perform operations directed to updating airspace awareness for unmanned aerial vehicles, according to at least one embodiment of the present disclosure. In a particular embodiment, the airspace awareness controller 113 cause the processor 104 to carry out the operations of: identifying, based on sensor data collected by an in-flight unmanned aerial vehicle (UAV), a classification of a detected object; determining, based on the sensor data, a location of the object; and generating in dependence upon the classification of the object and the location of the object, an airspace awareness update concerning the object.

In some examples, the computer executable instructions that implement the airspace awareness controller 113 cause the processor 104 to carry out the operations of: determining whether an airspace awareness map includes the object and generating the airspace awareness update in response to determining that the airspace awareness map omits the object. In some examples, the computer executable instructions that implement the airspace awareness controller 113 cause the processor 104 to carry out the operations of: identifying the classification of the detected object in dependence upon the sensor data and one or more object models. In some examples, the computer executable instructions that implement the airspace awareness controller 113 cause the processor 104 to carry out at least one of the operations of: populating the object on an airspace awareness map; providing the airspace awareness update to a central repository; and providing the airspace awareness update to one or more UAVs. In some examples, the computer executable instructions that implement the airspace awareness controller 113 cause the processor 104 to carry out the operations of: providing the airspace awareness update to one or more UAVs in dependence upon the classification of the object. In some examples, the computer executable instructions that implement the airspace awareness controller 113 cause the processor 104 to carry out the operations of: identifying, from an airspace awareness map, an expected location of an object; determining, based on sensor data collected by a UAV while in flight, that the object is missing; and generating, in response to determining that the object is missing, an airspace awareness update.

The control device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the control device 120 and to decrypt incoming message(s) using a public key of a device (e.g., the UAV 102 or the server 140 that sent the incoming message(s). Thus, in this implementation, communication between the UAV 102, the control device 120, and the server 140 are secure and trustworthy (e.g., authenticated).

The processor 122 is configured to execute instructions from the memory 124 to perform various operations. The instructions also include control instructions 130 that include instructions or code that cause the control device 120 to generate control data to transmit to the UAV 102 to enable the control device 120 to control one or more operations of the UAV 102 during a particular time period, as further described herein.

In the example of FIG. 1, the memory 124 of the control device 120 also includes communication instructions 131 that when executed by the processor 122 cause the processor 122 to transmit to the distributed computing network 151, transaction messages that include control instructions 130 that are directed to the UAV 102. In a particular embodiment, the transaction messages are also transmitted to the UAV and the UAV takes action (e.g., adjusting flight operations), based on the information (e.g., control data) in the message.

In the example of FIG. 1, the memory 124 of the control device 120 also includes an airspace awareness controller 135 implemented by computer executable instructions that, when executed by the processor 122, cause the processor 122 to perform operations directed to updating airspace awareness for unmanned aerial vehicles, according to at least one embodiment of the present disclosure. In a particular embodiment, the airspace awareness controller 135 cause the processor 122 to carry out the operations of: In a particular embodiment, computer executable instructions that implement the airspace awareness controller 135 cause the processor 122 to carry out the operations of: identifying, based on sensor data collected by an in-flight unmanned aerial vehicle (UAV), a classification of a detected object; determining, based on the sensor data, a location of the object; and generating, in dependence upon the classification of the object and the location of the object, an airspace awareness update concerning the object.

In some examples, the computer executable instructions that implement the airspace awareness controller 135 cause the processor 122 to carry out the operations of: determining whether an airspace awareness map includes the object and generating the airspace awareness update in response to determining that the airspace awareness map omits the object. In some examples, the computer executable instructions that implement the airspace awareness controller 135 cause the processor 122 to carry out the operations of: identifying the classification of the detected object in dependence upon the sensor data and one or more object models. In some examples, the computer executable instructions that implement the airspace awareness controller 135 cause the processor 122 to carry out at least one of the operations of: populating the object on an airspace awareness map; providing the airspace awareness update to a central repository; and providing the airspace awareness update to one or more UAVs. In some examples, the computer executable instructions that implement the airspace awareness controller 135 cause the processor 122 to carry out the operations of: providing the airspace awareness update to one or more UAVs in dependence upon the classification of the object. In some examples, the computer executable instructions that implement the airspace awareness controller 135 cause the processor 122 to carry out the operations of: identifying, from an airspace awareness map, an expected location of an object; determining, based on sensor data collected by a UAV while in flight, that the object is missing; and generating, in response to determining that the object is missing, an airspace awareness update.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142) is configured to encrypt outgoing message(s) using a private key associated with the server 140 and to decrypt incoming message(s) using a public key of a device (e.g., the UAV 102 or the control device 120) that sent the incoming message(s). As will be explained further below, the outgoing and incoming messages may be transaction messages that include information associated with the UAV. Thus, in this implementation, communication between the UAV 102, the control device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configure to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments. The route instructions 148 may also include instructions receiving, by a server in a UAV transportation ecosystem, disinfection area data; accessing, by the server, UAV parameters for a type of UAV; determining, by the server in dependence upon the disinfection area data and the UAV parameters, a number of UAVs needed to complete a coordinated aerial disinfection of a disinfection area within a time limit; and partitioning, by the server, the disinfection area into a plurality of partitions, wherein the number of partitions is equal to the number of UAVs. The server 140 may be configured to transmit the route information 110, including disinfection route information, to the UAV 102.

The instructions may also include control instructions 150 that include instructions or code that cause the server 140 to generate control data to transmit to the UAV 102 to enable the server 140 to control one or more operations of the UAV 102 during a particular time period, as further described herein.

In the example of FIG. 1, the memory 146 of the server 140 also includes an airspace awareness controller 145 implemented by computer executable instructions that, when executed by the processor 142, cause the processor 142 to perform operations directed to updating airspace awareness for unmanned aerial vehicles, according to at least one embodiment of the present disclosure. In a particular embodiment, computer executable instructions that implement the airspace awareness controller 145 cause the processor 142 to carry out the operations of: identifying, based on sensor data collected by an in-flight unmanned aerial vehicle (UAV), a classification of a detected object; determining, based on the sensor data, a location of the object; and generating, in dependence upon the classification of the object and the location of the object, an airspace awareness update concerning the object.

In some examples, the computer executable instructions that implement the airspace awareness controller 145 cause the processor 142 to carry out the operations of: determining whether an airspace awareness map includes the object and generating the airspace awareness update in response to determining that the airspace awareness map omits the object. In some examples, the computer executable instructions that implement the airspace awareness controller 145 cause the processor 142 to carry out the operations of: identifying the classification of the detected object in dependence upon the sensor data and one or more object models. In some examples, the computer executable instructions that implement the airspace awareness controller 145 cause the processor 142 to carry out at least one of the operations of: populating the object on an airspace awareness map; providing the airspace awareness update to a central repository; and providing the airspace awareness update to one or more UAVs. In some examples, the computer executable instructions that implement the airspace awareness controller 145 cause the processor 142 to carry out the operations of: providing the airspace awareness update to one or more UAVs in dependence upon the classification of the object. In some examples, the computer executable instructions that implement the airspace awareness controller 145 cause the processor 142 to carry out the operations of: identifying, from an airspace awareness map, an expected location of an object; determining, based on sensor data collected by a UAV while in flight, that the object is missing; and generating, in response to determining that the object is missing, an airspace awareness update.

In the example of FIG. 1, the memory 146 of the server 140 also includes communication instructions 147 that when executed by the processor 142 cause the processor 142 to transmit to the distributed computing network 151, transaction messages that include control instructions 150 or route instructions 148 that are directed to the UAV 102.

The distributed computing network 151 of FIG. 1 includes a plurality of computers 157. An example computer 158 of the plurality of computers 157 is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152) is configured to encrypt outgoing message(s) using a private key associated with the computer 158 and to decrypt incoming message(s) using a public key of a device (e.g., the UAV 102, the control device 120, or the server 140) that sent the incoming message(s). As will be explained further below, the outgoing and incoming messages may be transaction messages that include information associated with the UAV. Thus, in this implementation, communication between the UAV 102, the control device 120, the server 140, and the distributed computing network 151 are secure and trustworthy (e.g., authenticated).

The processor 142 is configured to execute instructions from the memory 154 to perform various operations. The memory 154 includes a blockchain manager 155 that includes computer program instructions for operating an UAV. Specifically, the blockchain manager 155 includes computer program instructions that when executed by the processor 152 cause the processor 152 to receive a transaction message associated with a UAV. For example, the blockchain manager may receive transaction messages from the UAV 102, the control device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The UAV 102, the control device 120, and server 140 are communicatively coupled via a network 118. For example, the network 118 may include a satellite network or another type of network that enables wireless communication between the UAV 102, the control device 120, the server 140, and the distributed computing network 151. In an alternative implementation, the control device 120 and the server 140 communicate with the UAV 102 via separate networks (e.g., separate short range networks).

In some situations, minimal (or no) manual control of the UAV 102 may be performed, and the UAV 102 may travel from the origin to the destination without incident. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the control device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the control device 120, the server 140, and any other control devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple of the devices of the system 100 in a manner that maintains security of the shared blockchain data structure as a public (i.e., available to other devices) and incorruptible (or tamper evident) ledger. Alternatively, as in FIG. 1, the blockchain 156 is stored in a distributed manner in the distributed computing network 151.

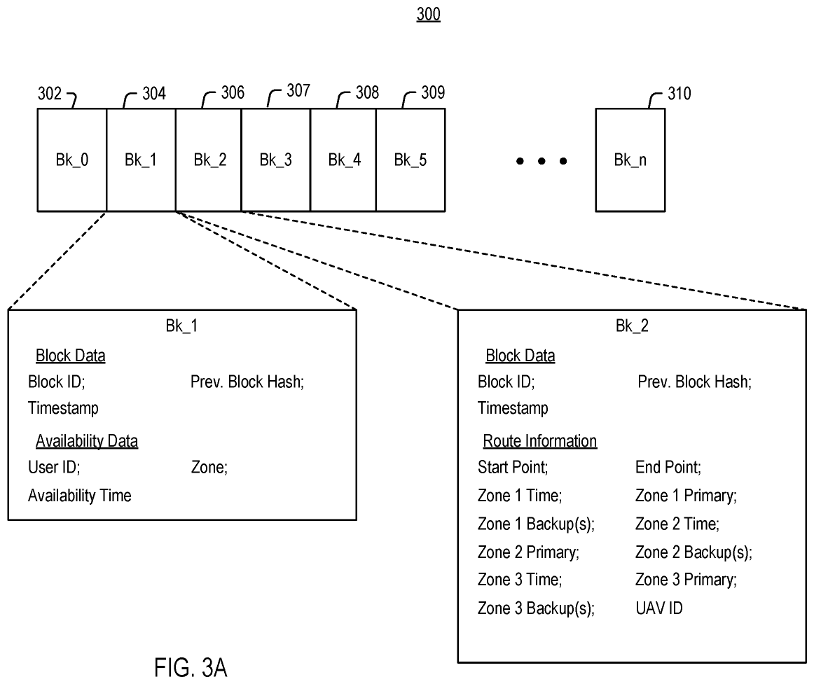

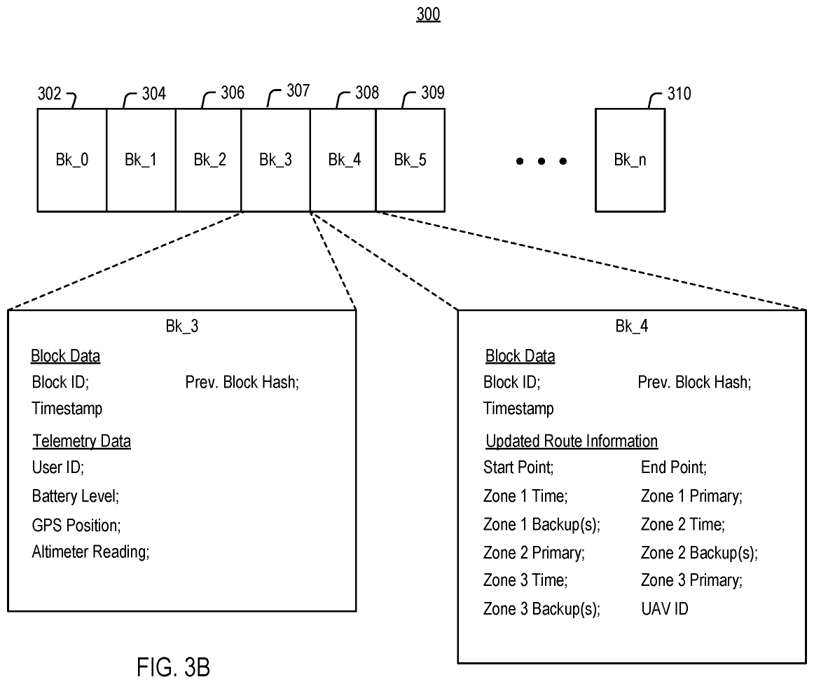

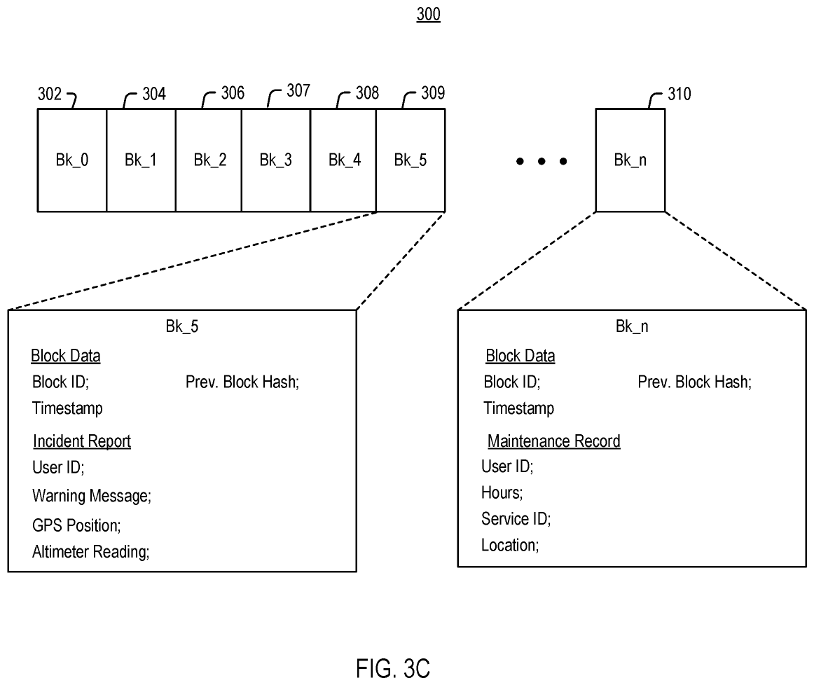

The blockchain data structure 156 may include, among other things, route information associated with the UAV 102, the telemetry data 107, the control instructions 130; and the route instructions 148. For example, the route information 110 may be used to generate blocks of the blockchain data structure 156. A sample blockchain data structure 300 is illustrated in FIGS. 3A-3C. Each block of the blockchain data structure 300 includes block data and other data, such as availability data, route data, telemetry data, service information, incident reports, etc.

The block data of each block includes information that identifies the block (e.g., a block ID) and enables the devices of the system 100) to confirm the integrity of the blockchain data structure 300. For example, the block data also includes a timestamp and a previous block hash. The timestamp indicates a time that the block was created. The block ID may include or correspond to a result of a hash function (e.g., a SHA256 hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk_0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk 2 306 and the previous hash value from the block Bk_1 304. The block Bk_n 310 includes other data and a hash value based on the other data of the block Bk_n 310 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain 156.

FIG. 3B also depicts the block BK_4 308 as including updated route information having a start point, an endpoint, and a plurality of zone times and backups, along with a UAV ID. In a particular embodiment, the control device 120 or the server 140 may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain 156.

FIG. 3C depicts the block BK_5 309 as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 includes software that is configured to receive telemetry information from an airborne UAV and track the UAV's progress and status. The server 140 is also configured to transmit in-flight commands to the UAV. Operation of the control device and the server may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 119 or through direct communication with the server 140.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 180 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographical data server 190 may include a processor 192, memory 194, and communication circuitry 198. The memory 194 of the topographical data server 190 may include operating instructions 196 that when executed by the processor 192 cause the processor to provide the topographical data that indicates information about terrain, places, structures, transportation, boundaries, hydrography, orthoimagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, orthoimagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub1 GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

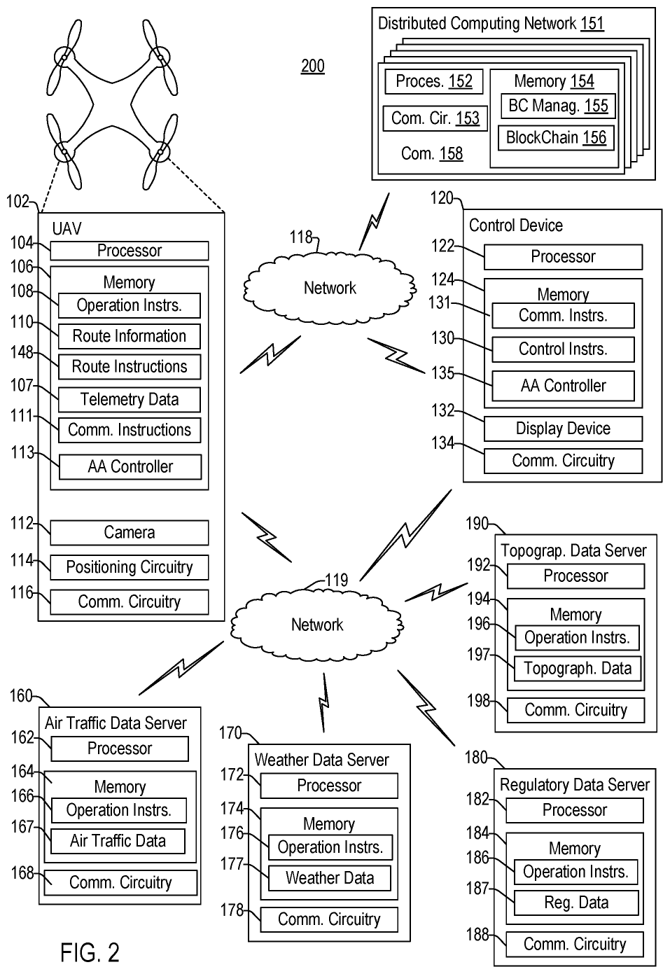

For further explanation, FIG. 2 sets forth a block diagram illustrating another implementation of a system 200 for operating a UAV. Specifically, the system 200 of FIG. 2 shows an alternative configuration in which one or both of the UAV 102 and the server 140 may include route instructions 148 for generating route information. In this example, instead of relying on a server 140 to generate the route information, the UAV 102 and the control device 120 may retrieve and aggregate the information from the various data sources (e.g., the air traffic data server 160, the weather data server 170, the regulatory data server 180, and the topographical data server 190). As explained in FIG. 1, the route instructions may be configured to use the aggregated information from the various source to plan and select a flight path for the UAV 102.

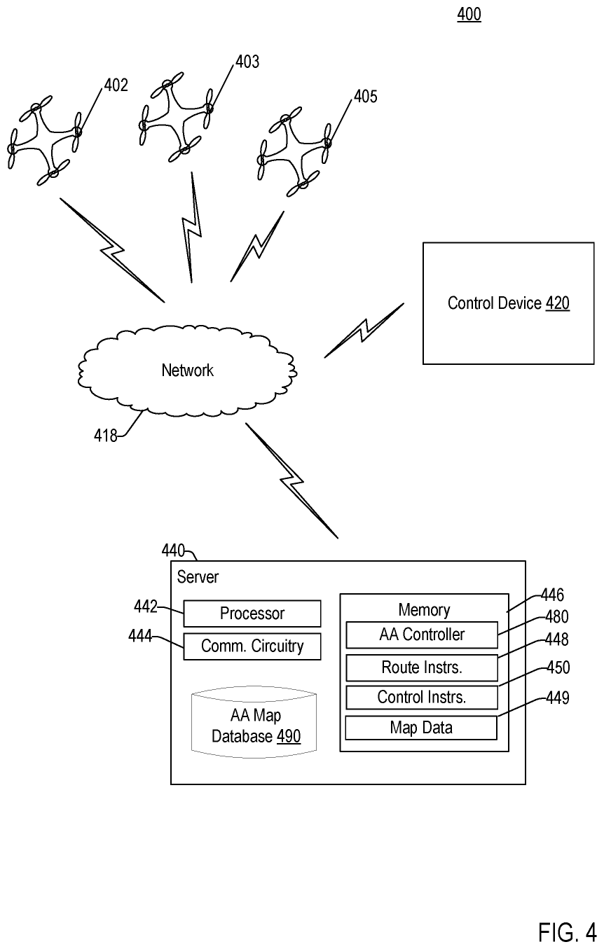

FIG. 4 is a block diagram illustrating a particular implementation of a system 400 for updating airspace awareness for unmanned aerial vehicles according to some embodiments of the present disclosure. The system 400 includes the first UAV 402, a second UAV 403, a third UAV 405, which may be similarly configured to the UAV 102 of FIG. 1 and FIG. 2. The system 400 also includes a control device 420 may be similarly configured to the control device 120 of FIG. 1 and FIG. 2. The system 400 also includes a map server 440 that may be implemented by the server 140 of FIG. 1 or by another computing device communicating with the UAVs 402, 403, 405 and/or the control device 420. When the map server 440 is another computing device not depicted in FIG. 1 or FIG. 2, the map server may also include a processor 442 coupled to communication circuitry 444 and a memory 446. The memory 446 may include operating instructions 448 that are configured to transmit map data 449 via the communication circuitry 444 to the UAVs 402, 403, 405 and/or the control device 420. In some examples, the map data 449 includes data related to an airspace awareness map. The memory may also include control instructions 450 that include instructions or code that cause the server 440 to generate control data to transmit to one or more UAVs 402, 403, 405 to enable the server 440 to control one or more operations of the UAV during a particular time period. The memory 446 may also include an airspace awareness controller 480 implemented by computer executable instructions that cause processor 442 to carry out the operations: identifying, based on sensor data collected by an in-flight unmanned aerial vehicle (UAV), a classification of a detected object; determining, based on the sensor data, a location of the object; and generating, by a controller and in dependence upon the classification of the object and the location of the object, an airspace awareness update concerning the object.

In some examples, the computer executable instructions that implement the airspace awareness controller 480 cause the processor 442 to carry out the operations of: determining whether an airspace awareness map includes the object and generating the airspace awareness update in response to determining that the airspace awareness map omits the object. In some examples, the computer executable instructions that implement the airspace awareness controller 480 cause the processor 442 to carry out the operations of: identifying the classification of the detected object in dependence upon the sensor data and one or more object models. In some examples, the computer executable instructions that implement the airspace awareness controller 480 cause the processor 442 to carry out at least one of the operations of: populating the object on an airspace awareness map; providing the airspace awareness update to a central repository; and providing the airspace awareness update to one or more UAVs. In some examples, the computer executable instructions that implement the airspace awareness controller 480 cause the processor 442 to carry out the operations of: providing the airspace awareness update to one or more UAVs in dependence upon the classification of the object. In some examples, the computer executable instructions that implement the airspace awareness controller 480 cause the processor 442 to carry out the operations of: identifying, from an airspace awareness map, an expected location of an object; determining, based on sensor data collected by a UAV while in flight, that the object is missing; and generating, in response to determining that the object is missing, an airspace awareness update.

The map server 440 maintains an airspace awareness map database 490. In some examples, the airspace awareness map database 490 includes indications of particular locations that should be avoided by a UAV because they are locations where UAV flight would, for example, pose a risk to the UAV, pose a public safety risk, or violate some law, regulation, or geofence. While in some examples the map database 490 identifies the location with a tag indicating the location that should be avoided in a UAV flight path, in other examples the map database 490 may also include a tag of an object at the location that is to be avoided. For example, the tag may include the type of object or other details about the object. The type of object may be, for example, person, animal, vehicle, structure, liquid, vegetation, smoke, fire, and so on. In some examples, the airspace awareness map database 490 also includes locations of interest. In such examples, the airspace awareness map database 490 may include a tag of an object of interest at a particular location.

In some implementations, the map server 440 acts as a central repository for the airspace awareness map database 490 and modifications to it. In these implementations, the server 440 provides airspace awareness map data 449 to the UAVs 402, 403, 405 and the control device 420 for route planning, navigation, and UAV missions. Accordingly, the memory the UAVs 402, 403, 405 or the memory of the control device 420 may include a local copy of an airspace awareness map generated from airspace awareness map data 449. The UAVs 402, 403, 405 or the control device 420 may load an airspace awareness map relevant to the intended flight path of the UAV from the map server 440 during prior to initiating a mission. The UAVs 402, 403, 405 or the control device 420 may also load an airspace awareness map relevant to the current flight path of the UAV from the map server 440 on-demand while the UAV is in flight. In addition to route planning and navigation, the UAVs 402, 403, 405 and the control device 420 may load an airspace awareness map from the map sever 440 that includes tags and locations of objects that are relevant to the UAV's mission. The UAVs 402, 403, 405 or the control device 420 may also generate updates to the airspace awareness map database 490 that are provided to the map server 440 based on in-flight observations, and the server 440 may propagate updates received from one UAV to other UAVs.

In a particular embodiment, the UAVs 402, 403, 405, the map server 440, the control device 420 are coupled for communication to a network 418. The network 418 may include a cellular network, a satellite network or another type of network that enables wireless communication between the UAVs 402, 403, 405, the server 440, the control device 420. In an alternative implementation, the UAVs 402, 403, 405, the server 440, the control device 420 communicate with each other via separate networks (e.g., separate short range networks). While only one control device 420 is illustrated, it will be appreciated that each UAV 402, 403, 405 may be operated by a distinct control device or the same control device.

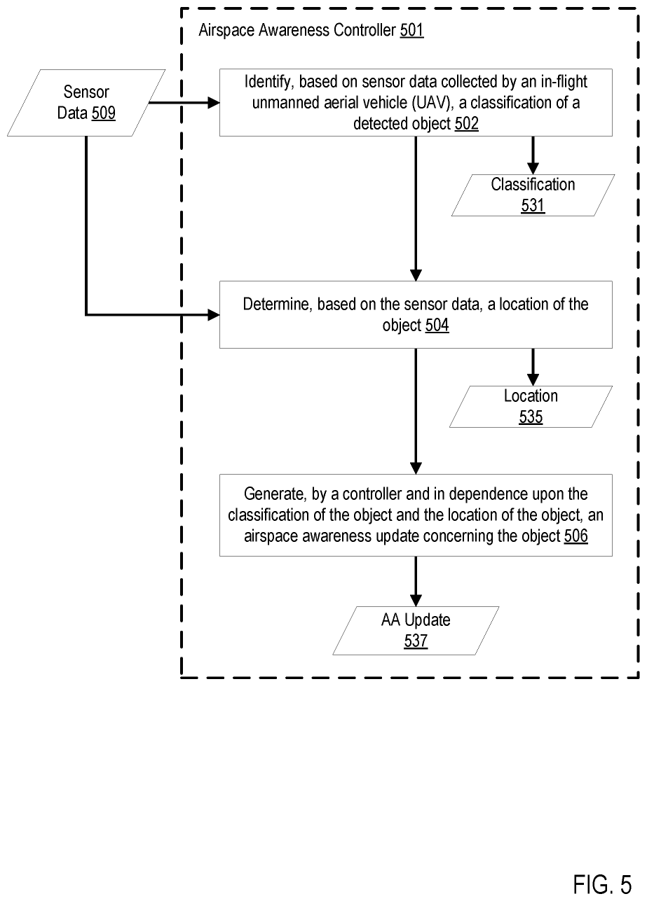

For further explanation, FIG. 5 sets forth a flow chart illustrating an exemplary method for updating airspace awareness for unmanned aerial vehicles in accordance with some embodiments of the present disclosure. The example method of FIG. 5 includes identifying 502, based on sensor data 509 collected by an in-flight unmanned aerial vehicle (UAV), a classification 531 of a detected object 533. In some examples, identifying 502, based on sensor data 509 collected by an in-flight UAV, a classification 531 of a detected object 533 is carried out by an airspace awareness controller 501. In some examples, the airspace awareness controller 501 may be implemented by the airspace awareness controller 113 of the UAV 102 in FIG. 1 and FIG. 2. In other examples, the airspace awareness controller 501 may be implemented by the airspace awareness controller 135 of the control device 120 in FIG. 1 and FIG. 2. In further examples, the airspace awareness controller 501 may be implemented by the airspace awareness controller 145 of the server 140 in FIG. 1. In still further examples, the airspace awareness controller 501 may be implemented by the airspace awareness controller 480 of the map server 440 in FIG. 4.

The sensor data 509 includes data collected from one or more sensors of a UAV (e.g., the UAV 102 of FIG. 1) such as optical still or video cameras, monocular or stereo vision cameras, thermal imaging cameras, LIDAR, SONAR, RADAR, and other sensors useful in detecting an object. The sensor data 509 is collected by the UAV and utilized by the UAV for object detection and object classification, or the collected sensor data 509 is streamed to a remote device such as a UAV control device (e.g., the control device 120 of FIG. 1) or a server (e.g., the server 140 of FIG. 1 or the map server 440 of FIG. 4) for object detection and object classification.

In some embodiments, identifying 502, based on sensor data 509 collected by an in-flight UAV, a classification 531 of a detected object 533 is carried out through pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and classification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the object 533 within the image. Additionally or alternatively, an image of the object 533 may be generated from LIDAR, RADAR, or SONAR sensor data. For example, line scanning LIDAR may be employed to capture a representation of the object 533 by illuminating the object 533 with laser light and measuring the time the reflection of the light takes to return to the sensor. Differences in return times and light wavelengths can then be used to generate a three-dimensional representation of the target. A variety of sensors may be used to obtain imagery of the detected object 533. In fact, given the variety of sensor equipped on a UAV, sensor data 509 from these sensors may be combined to further enhance an image of the object 533. For example, an image from a camera may be combined with imagery generated from LIDAR sensor data and imagery generated from SONAR sensor data. The imagery generated from the sensor data of each sensor may be transformed into the same coordinate system (and with the same scale and perspective) such that the images may be overlaid. These image layers may then be flattened into a single image with enhanced features that would not have been detected based on any single sensor. This flattened image may include enhanced features that provide better image resolution for feature detection and extraction.

Feature detection and extraction techniques may be applied to the image to obtain a set of features useful in classifying or identifying the object 533. In some examples, convolution neural networks, support vector machines, and/or deep learning methods are used to extract features of the object and/or classify the object. For example, object recognition techniques such as region-based convolutional neural networks (R-CNN) or You Only Look Once (YOLO) may be useful in identifying 502, based on sensor data 509 collected by an in-flight UAV, a classification 531 of a detected object 533. In some examples, template-based image matching may be used in which a set of sample points of the extracted features are compared to image templates for object classification or identification. Other object recognition and machine vision techniques, such as optical character recognition (OCR) and shape recognition technology (SRT) may be useful in object recognition, classification, and identification. Readers will appreciate that an object may be part of a scene of objects, such that the scene provides context for object identification. A variety of other machine vision and object recognition, classification, and identification techniques, as will occur to those of skill in the art, may be utilized to identify an object type of a detected object.

In some examples, identifying 502, based on sensor data 509 collected by an in-flight UAV, a classification 531 of a detected object 533 includes identifying object types that are particularly relevant to UAV operation and UAV missions. For example, exterior artifacts such as structures and vehicles are more likely to be relevant to UAV operation and UAV missions than interior artifacts such as furniture or appliances. As such, the airspace awareness controller 501 may employ a particular set of object classifications for object or object type identification. For example, object classifications may include person, animal, vehicle, structure, liquid, vegetation, smoke, fire, and so on, that may be encountered during UAV flight. In some examples, subtypes or particular instances of an object classification, including particular characteristics of the object, may be identified. For example, the object could be a particular person or a particular vehicle. In such instances, the object may be identified using techniques such as facial recognition or other identification techniques. In other examples, the object to be detected can be a set of persons, such as persons having a particular characteristic. In still other examples of subtypes of object classifications, a body of liquid may be further differentiated as a lake, a river, etc.; a structure may be differentiated as a building, a communications tower; etc.; an animal by be differentiated by species, etc.

In some examples, the object classification is identified based on an association with another object. For example, the controller 501 may recognize a tall structure and identify the structure as a high-tension power line structure based on identified power lines attached to it. In another example, a characteristic may include patterns for recognition such as a bar code or quick response (QR) code, an object temperature, a movement characteristic such as smooth or intermittent, a gait style, object emissions, sound patterns, or other characteristics. Identifying the object type of a particular object may rely upon a plurality of sensors. For example, the sensor data may include information from a camera for a visual identification, a microphone for audio detection, a GPS system for identifying location, and/or a thermal sensor for identifying a temperature.

The example method of FIG. 5 also includes determining 504, based on the sensor data 509, a location 535 of the object 533. In some examples, determining 504, based on the sensor data 509, a location 535 of the object 533 is carried out by the airspace awareness controller 501 analyzing sensor data 509 to determine a location of 535 of an object 533 based on the relationship of the object 533 to one or more known locations. In some examples, the location of the object 533 may be determined based on the location of the UAV (e.g., x-y or latitude-longitude location) determined from a GPS receiver, the compass orientation of the UAV, and the distance between the UAV and the object 533 as determined from, for example, LIDAR or SONAR data. The location of the object 533 may be determined using a variety of techniques based on knowing the location of the UAV from a GPS receiver.

To determine the location of the object 533, a number of techniques may be employed to determine the distance between the UAV and the object 533 based on the sensor data 509. In one example, stereo cameras are used to capture two images of the object from different viewpoints. In this example, an image processing algorithm can identify the same point in both images and calculate the distance triangulation. In another example, high frequency SONAR pulses are transmitted toward the object and the time it takes for the signal to reflect off the object 533 and return to the UAV is used to determine the distance to the object 533. In yet another example, a time-of-flight camera that includes an integrated light source and a camera is used to measure distance information for every pixel in the image by emitting a light pulse flash and calculating the time needed for the light to reach the object 533 and reflect back to the camera. In yet another example, LIDAR is used to determine how long it takes for a laser pulse to travel from the sensor to the object 533 and back and calculate the distance from the speed of light. In still another example, image processing algorithms are used to match sequential images taken by the same camera to determine distance to objects in the image.

The example method of FIG. 5 also includes generating 506, by a controller and in dependence upon the classification 531 of the object and the location 535 of the object 533, an airspace awareness update 537 concerning the object 533. In some contexts, airspace awareness concerns not only objects that may be encountered by a UAV in the air, but also objects that may be on the ground below the airspace traversed by the UAV. For example, airspace awareness may concern tall objects (e.g., a building, a crane, a cell tower) that the UAV or UAV operator should be aware of for route planning and navigation (e.g., for collision avoidance). As another example, airspace awareness may concern an area densely populated by people that the UAV or UAV operation should be aware of when flying over the area (e.g., a UAV carrying a heavy package should avoid the area). Moreover, airspace awareness may concern the identification of objects, in the air or on the ground, that are central to completing the UAV's flight mission.

In some examples, the airspace awareness update 537 includes the location 535 of the object 533 and a tag associated with the location 535. For example, the tag may designate that the location 535 is an area to avoid based on the classification 531 of an object 533. In such an example, based on the detection of numerous objects classified as people, it may be determined that a location is densely populated and thus a UAV flight path should avoid passing over the location. In another example, the tag may designate that the location 535 is an area of interest based on the classification 531 of an object 533. In such an example, based on the detection of numerous objects classified as cows, it may be determined that the area is of particular interest to a UAV tasked with the mission of counting cattle on a ranch.

In some examples, the tag associated with the location 535 in the airspace awareness update 537 includes the object classification 531 of the detected object 533. For example, the tag may indicate that the location is the site of an object classified as a ‘construction crane,’ a ‘cell tower,’ a ‘fire’, a ‘vehicle’, a ‘person’, and so on. In further examples, the tag associated with the location 535 in the airspace awareness update 537 includes the object classification 531 of the detected object 533 and additional characteristics of the object 533. For example, the tag may indicate ‘vehicle’ and include the make and model identified as a subtype of the classification 531 or the tag may indicate ‘cell tower’ and include the height of the cell tower or the tag may indicate ‘building’ and include dimensions of the building. In still further examples, the tag associated with the location 535 in the airspace awareness update 537 includes the object classification 531 of the detected object 533 and additional flight parameters or limitations. For example, the tag may indicate ‘public space’ and indicate a cargo restriction or the tag may indicate ‘structure’ and include a minimum flight altitude to safely navigate over the structure.

In some embodiments, generating 506, by a controller and in dependence upon the classification 531 of the object and the location 535 of the object 533, an airspace awareness update 537 concerning the object 533 includes transmitting the airspace awareness update 537 to one or more UAV system components such as a UAV, a UAV control device, a distributed computing network, a server, or a user device coupled to the UAV system (e.g., the UAV system 100 of FIG. 1). For example, the airspace awareness update 537 may be transmitted in a transaction message. In some examples, generating 506, by a controller and in dependence upon the classification 531 of the object and the location 535 of the object 533, an airspace awareness update 537 concerning the object 533 includes generating an alert containing the update 537 to a UAV operator or other user, for example, via a device's user interface.

In some implementations, the airspace awareness update modifies an airspace awareness map. In some examples, one or more components of a UAV system (e.g., the system 100 of FIG. 1), such as UAV, control device, server, a distributed computing network, or other component, includes an airspace awareness map database (e.g., the airspace awareness map database 490 of FIG. 4), while in other examples an external airspace awareness map database may be coupled to one or more components of the UAV system. The airspace awareness map database includes, for example, a database of object tags indexed by location. An airspace awareness map may be generated from the airspace awareness map database by correlating the locations associated with the object tags to locations on a navigational map and overlaying the tags on the navigational map. A modification to the airspace awareness map adds an entry to the airspace awareness map that includes a location and an object tag (e.g., an object identification or classification). In some implementations, the airspace awareness update is made in the form of an API call to a map server that maintains the airspace awareness map database, where the API call includes the location and tag for the object to be added.

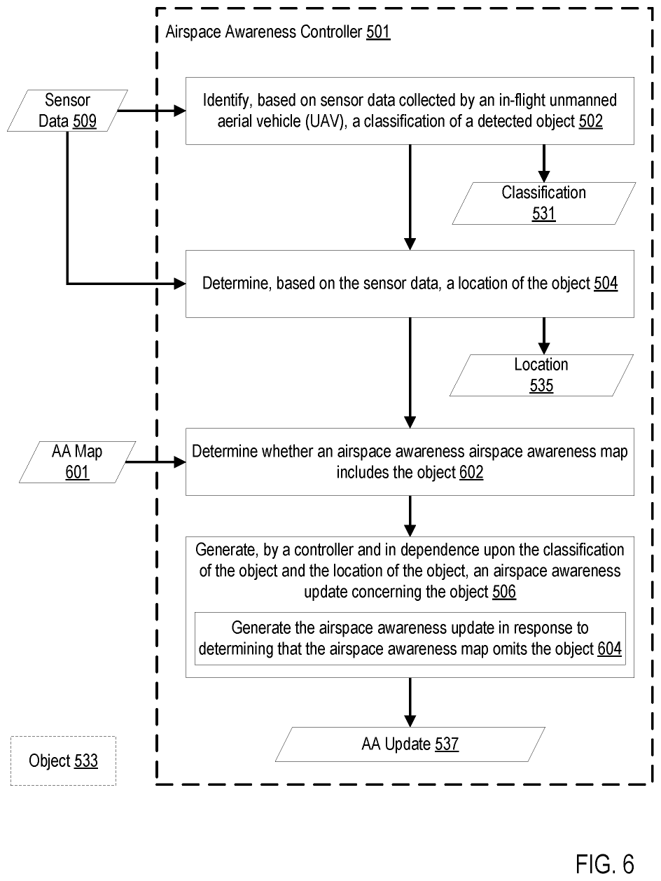

For further explanation, FIG. 6 sets forth a flow chart illustrating another example method for updating airspace awareness for unmanned aerial vehicles in accordance with some embodiments of the present disclosure. Like the method of FIG. 5, the example method of FIG. 6 also includes identifying 502, based on sensor data 509 collected by an in-flight unmanned aerial vehicle (UAV), a classification 531 of a detected object 533; determining 504, based on the sensor data 509, a location 535 of the object 533; and generating, by a controller and in dependence upon the classification 531 of the object and the location 535 of the object 533, an airspace awareness update 537 concerning the object 533.

The example method of FIG. 6 also includes determining 602 whether an airspace awareness map 601 includes the object 533. In some examples, determining 602 whether an airspace awareness map 601 includes the object 533 is carried out by looking up the identified location of the detected object 533 in an airspace awareness map database (e.g., the airspace awareness map database 490 of FIG. 4) to determine whether an entry for the location includes a tag for an object that matches the detected object. For example, for a particular location, if the classification 531 of the detected object 533 matches an object classification in a tag in the airspace awareness map database, it may be determined that the airspace awareness map 601 includes the object 533. However, if the classification 531 of the detected object 533 does not match an object classification in a tag in the airspace awareness map database for the particular location, or if there is no entry in the airspace awareness map data base that includes the particular location, it may be determined that the airspace awareness map 601 does not include the object 533. For example, the airspace awareness map database may include a tag indicating a ‘building’ object classification for location X, whereas the classification of the detected object at location X may be ‘mailbox.’ In such an example, it is beneficial to add another entry to the airspace awareness map database that includes a tag for ‘mailbox’ associated with location X so that a UAV searching for mailboxes may be directed to location X. On the other hand, the airspace awareness map database may include a tag indicating a ‘mailbox’ object classification for location X, whereas the classification of the detected object at location X may be ‘building.’ In such an example, it is beneficial to add another entry to the airspace awareness map database that includes a tag for ‘building’ at location X so that a UAV will not collide with the building. As another example, the classification of the detected object at location Y may be ‘construction crane’ but there is no entry in the airspace awareness map database for location Y because the construction crane was recently erected. In such an example, it is beneficial to add an entry to the airspace awareness map database to include a tag for ‘construction crane’ at location Y so that a UAV will not collide with the crane.

In the example method of FIG. 6, generating, by a controller and in dependence upon the classification 531 of the object and the location 535 of the object 533, an airspace awareness update 537 concerning the object 533 includes generating 604 the airspace awareness update 537 in response to determining that the airspace awareness map 601 omits the object 533. In some examples, generating 604 the airspace awareness update 537 in response to determining that the airspace awareness map 601 omits the object 533 is carried out by determining, for a particular location, that the classification 531 of the detected object 533 does not match an object classification in a tag in the map database, or that there is no tag for the particular location, and generating the airspace awareness update 537. Updating the airspace awareness map 601 with redundant information may be avoided by only generating the airspace awareness update 537 in response to determining that the airspace awareness map 601 omits the object 533, thereby minimizing communication and conserving system resources.

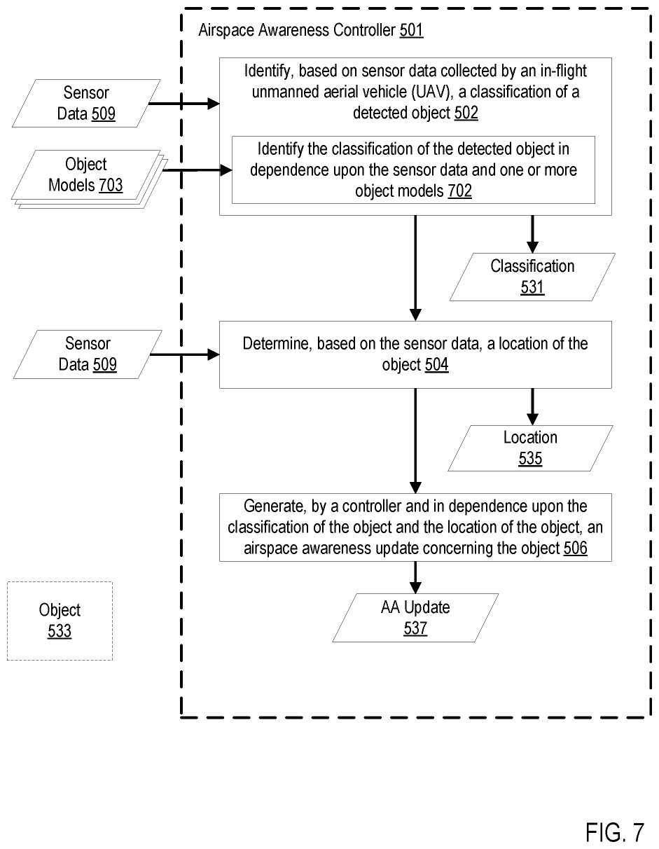

For further explanation, FIG. 7 sets forth a flow chart illustrating another example method for updating airspace awareness for unmanned aerial vehicles in accordance with some embodiments of the present disclosure. Like the method of FIG. 5, the example method of FIG. 7 also includes identifying 502, based on sensor data 509 collected by an in-flight unmanned aerial vehicle (UAV), a classification 531 of a detected object 533; determining 504, based on the sensor data 509, a location 535 of the object 533; and generating, by a controller and in dependence upon the classification 531 of the object and the location 535 of the object 533, an airspace awareness update 537 concerning the object 533.

In the example method of FIG. 7, identifying 502, based on sensor data 509 collected by an in-flight unmanned aerial vehicle (UAV), a classification 531 of a detected object 533 includes identifying 702 the classification 531 of the detected object 533 in dependence upon the sensor data 509 and one or more object models 703. In some examples, identifying 702 the classification 531 of the detected object 533 in dependence upon the sensor data 509 and one or more object models 703 is carried out by the airspace awareness controller 501 loading one or more object models 703 and comparing the object pattern recognized from the sensor data 509. For example, an artificial neural network may be trained on a set of training images for a particular object to generate an object model for that object. The object model may include a set of features represented by shape context vectors. Once features have been extracted from the object pattern recognized from the image(s) generated from the sensor data 509, the extracted features may be compared to the set of features for a candidate object model. This comparison may be scored based on the matching of extracted features of the detected object and features of the object model. The process is then repeated for other candidate object models. Based on the scores, a candidate object model may be selected as the matching object model upon which the detected object is classified.

To reduce the amount of computation required to compare the detected object to object models 703, the entire set of object models may be filtered to produce the set of candidate object models. Filtering may be applied based on characteristics of the detected object or scene, conditions present in the UAV, one or more UAV missions, or combinations thereof. As one simplified example, based on the altitude of the UAV and the camera angle, it may be easily determined that the scene of the image that includes the detected object is a skyscape. This precludes object models that are ground-based such a people, animals, vehicles. Based on a mission of collision avoidance, the set of candidate models may be narrowed based on the altitude of the UAV or the detected object, which may preclude object models for houses and retail stores and small office buildings. Based on the location of the UAV and the pastoral nature of the captured scene (e.g., a rural location, sparsely detected structures, observable greenery), the set of candidate object models may be filtered to exclude an office building, apartment building, or a construction crane. Ultimately, the set of candidate models may be, for example: aircraft, cell tower, or radio tower. If the detected object is actually a radio tower, the comparison of the extracted features of the detected object to the radio tower object model will score high than the comparisons based on the aircraft object model and the cell tower object model.

In some examples, the object models 703 loaded by the airspace awareness controller 501 may be specific to the UAV mission. For example, when the UAV mission is to find people, object models for people are loaded by the airspace awareness controller. When the UAV mission is to find cows, cow object models are loaded by the airspace awareness controller. In this way, the number of candidate object models may be further filtered and thus the number of comparisons may be reduced, thereby conserving computation resources and expediting a match result.

In some examples where the airspace awareness controller 501 is implemented in the UAV (i.e., the airspace awareness controller 113 of the UAV 102 in FIG. 1), the UAV may be preloaded with a set of object models 703 in the memory of the UAV (e.g., the memory 106 of FIG. 1) prior to executing a mission. For example, the UAV may be preloaded with object models 703 that are specific to the UAV's mission. The UAV may also receive object models 703 in-flight that are transmitted from a remote device (e.g., the controller 120 or the server 140 of FIG. 1 or the map server 440 of FIG. 4).

In some examples where the airspace awareness controller 501 is implemented in a control device (e.g., the airspace awareness controller 135 of the control device 120 of FIG. 1), the control device may store a set of object models 703 locally in the memory of the control device (e.g., the memory 124 of FIG. 1) prior to operating a UAV mission or the control device may receive object models 703 that are transmitted from a remote device (e.g., the server 140 of FIG. 1 or the map server 440 of FIG. 4) while the UAV is in-flight.

In some examples where the airspace awareness controller 501 is implemented in a server (e.g., the airspace awareness controller 145 of the server 140 of FIG. 1 or the airspace awareness controller 480 of the map server 440 of FIG. 4), the server may store all object models such that the server acts as a central repository for object models. The server may provide one or more object models from the entire set of object models, where the one or more object models are used in carrying out the UAV mission. In some examples, a standard set of object models may be provided for typical UAV flight operation (e.g., UAV navigation, collision avoidance, and route planning), while a specialized set of object models may be provided for a particular UAV mission. In some examples, a set of object models are stored on the same server as a map server that includes an airspace awareness map database.

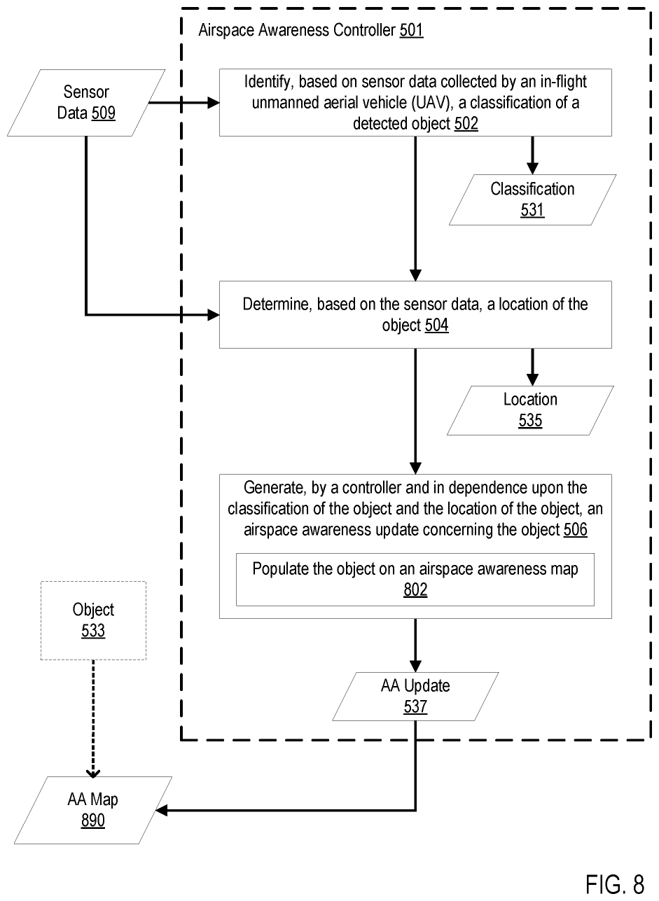

For further explanation, FIG. 8 sets forth a flow chart illustrating another example method for updating airspace awareness for unmanned aerial vehicles in accordance with some embodiments of the present disclosure. Like the method of FIG. 5, the example method of FIG. 8 also includes identifying 502, based on sensor data 509 collected by an in-flight unmanned aerial vehicle (UAV), a classification 531 of a detected object 533; determining 504, based on the sensor data 509, a location 535 of the object 533; and generating, by a controller and in dependence upon the classification 531 of the object and the location 535 of the object 533, an airspace awareness update 537 concerning the object 533.

In the example method of FIG. 8, generating, by a controller and in dependence upon the classification 531 of the object and the location 535 of the object 533, an airspace awareness update 537 concerning the object 533 includes populating 802 the object 533 on an airspace awareness map 890. In some examples, populating 802 the object 533 on an airspace awareness map 890 is carried out by the airspace awareness controller 501 storing an entry for the object that includes the object location and the object tag in an airspace awareness maps database. In these examples, the airspace awareness maps database may be stored in local memory accessible by the airspace awareness controller 501. In some examples, the entry in the airspace awareness map database is assigned a unique identifier that may also be used as an identifier for the object. A location in the airspace awareness map database may be specified by a GPS coordinate, a perimeter around a GPS coordinate, a map partition, an address, or by some other means. The size or dimensions of an object may be estimated based on the distance between the UAV and the object and the scale of the image. Furthermore, the UAV may collect sensor data from multiple viewpoints to provide more information usable to estimate the dimensions of an object. These dimensions may be reflected in the airspace awareness map database. Consider an example where the airspace awareness map database is indexed by map partition where, for example, each partition represents 10 square feet of a navigational map. Where multiple smaller objects are present in that partition, the partition may be associated with multiple object tags in the database. Where a larger object spans multiple map partitions, an object tag may be associated with multiple partitions to reflect the dimensions of the object. Consider another example where the airspace awareness map database is indexed by GPS coordinate. The GPS coordinate may be associated with one or more object tags, and each object tag may include dimensional characteristics to reflect the space occupied by the object.

In some examples where the airspace awareness controller 501 is implemented in the UAV (i.e., the airspace awareness controller 113 of the UAV 102 in FIG. 1), the UAV may include an airspace awareness map database stored in the memory of the UAV (e.g., the memory 106 of FIG. 1). In such an example, populating 802 the object 533 on an airspace awareness map 890 is carried out by the airspace awareness controller of the UAV updating an on-board airspace awareness map database. In some examples, this airspace awareness map database includes map data and object tags that correspond only to the UAV's intended flight path to conserve memory resources. Updates made to the airspace awareness map 890 may be propagated to a control device or to a larger airspace awareness map database when the UAV has returned to base.

In some examples where the airspace awareness controller 501 is implemented in a control device (e.g., the airspace awareness controller 135 of the control device 120 of FIG. 1), the control device may include an airspace awareness map database stored in the memory of the control device (e.g., the memory 124 of FIG. 1). In such an example, populating 802 the object 533 on an airspace awareness map 890 is carried out by the airspace awareness controller of the control device updating a local airspace awareness map database. In some examples, this airspace awareness map database includes map data and object tags that correspond only to the UAV's intended flight path to conserve memory resources. Updates made to the airspace awareness map 890 may be propagated to a larger remote airspace awareness map database during a synchronization process.

In some examples where the airspace awareness controller 501 is implemented in a server (e.g., the airspace awareness controller 145 of the server 140 of FIG. 1 or the airspace awareness controller 480 of the map server 440 of FIG. 4), the server may store the airspace awareness map database in attached storage (e.g., memory 146 of server 140 in FIG. 1 or memory 446 of map server 440 in FIG. 4). The server may receive updates from numerous connected UAV and UAV controllers in a UAV network. In such an example, populating 802 the object 533 on an airspace awareness map 890 is carried out by the airspace awareness controller of the server updating a global airspace awareness map database for the UAV network.

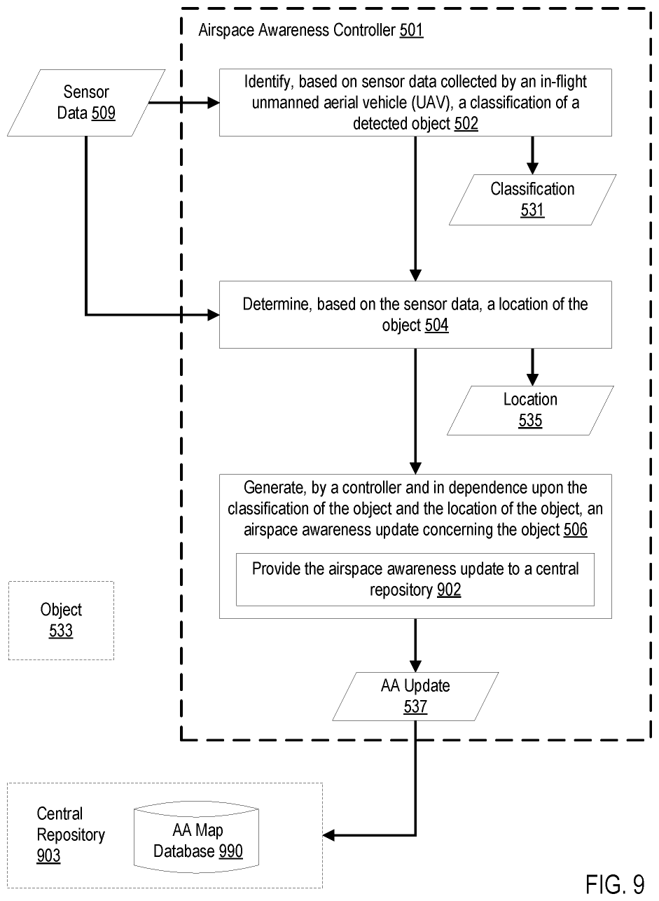

For further explanation, FIG. 9 sets forth a flow chart illustrating another example method for updating airspace awareness for unmanned aerial vehicles in accordance with some embodiments of the present disclosure. Like the method of FIG. 5, the example method of FIG. 9 also includes identifying 502, based on sensor data 509 collected by an in-flight unmanned aerial vehicle (UAV), a classification 531 of a detected object 533; determining 504, based on the sensor data 509, a location 535 of the object 533; and generating, by a controller and in dependence upon the classification 531 of the object and the location 535 of the object 533, an airspace awareness update 537 concerning the object 533.

In the example method of FIG. 9, generating, by a controller and in dependence upon the classification 531 of the object and the location 535 of the object 533, an airspace awareness update 537 concerning the object 533 includes providing 902 the airspace awareness update 537 to a central repository 903. In some examples, providing 902 the airspace awareness update 537 to a central repository 903 is carried out by the airspace awareness controller 501 (e.g., of a UAV or control device) providing the airspace awareness update 537 to a server (e.g., the server 140 of FIG. 1 or the map server 440 of FIG. 4) that maintains a global airspace awareness map database 990 for a UAV network. For example, the airspace awareness update 537 may be provided as an API call to the airspace awareness map database, as a transaction message, as a data manipulation language statement, or using other techniques that will occur to those of skill in the art. In response, the central repository 903 populates an airspace awareness map with the object 533.

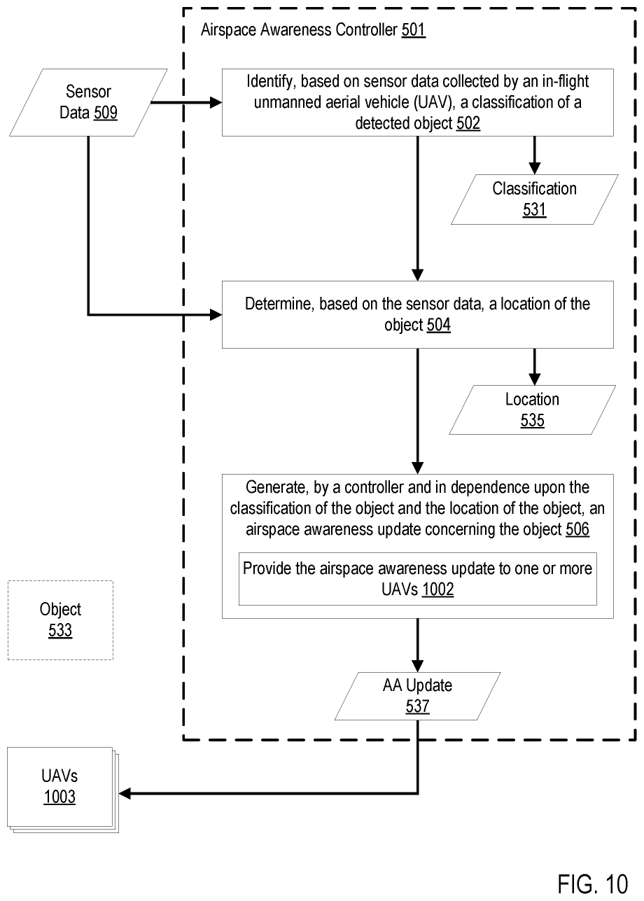

For further explanation, FIG. 10 sets forth a flow chart illustrating another example method for updating airspace awareness for unmanned aerial vehicles in accordance with some embodiments of the present disclosure. Like the method of FIG. 5, the example method of FIG. 10 also includes identifying 502, based on sensor data 509 collected by an in-flight unmanned aerial vehicle (UAV), a classification 531 of a detected object 533; determining 504, based on the sensor data 509, a location 535 of the object 533; and generating, by a controller and in dependence upon the classification 531 of the object and the location 535 of the object 533, an airspace awareness update 537 concerning the object 533.

In the example method of FIG. 10, generating, by a controller and in dependence upon the classification 531 of the object and the location 535 of the object 533, an airspace awareness update 537 concerning the object 533 includes providing 1002 the airspace awareness update 537 to one or more UAVs 1003. In some examples, providing 1002 the airspace awareness update 537 to one or more UAVs 1003 is carried out by the airspace awareness controller sending a message to one or more UAVs that includes the airspace awareness update 537. For example, the airspace awareness controller 501 may generate a transaction message directed to one or more UAVs 1003 that include the airspace awareness update 537.

In some examples where the airspace awareness controller 501 is implemented in a UAV (e.g., the UAV 402 of FIG. 4), the UAV may provide the airspace awareness update 537 to one or more other UAVs (e.g., the UAVs 403, 405 of FIG. 4). For example, the update 537 may be provided from one UAV to another UAV while both UAVs are in-flight. In some examples where the airspace awareness controller 501 is implemented in a control device (e.g., the control device 420 of FIG. 4), the control device may provide the airspace awareness update 537 to one or more UAVs (e.g., the UAVs 403, 405 of FIG. 4) while the UAV is in-flight. In some examples where the airspace awareness controller 501 is implemented in a server (e.g., the map server 440), the server may provide the airspace awareness update 537 to one or more UAVs (e.g., the UAVs 403, 405 of FIG. 4) while the UAV is in-flight.

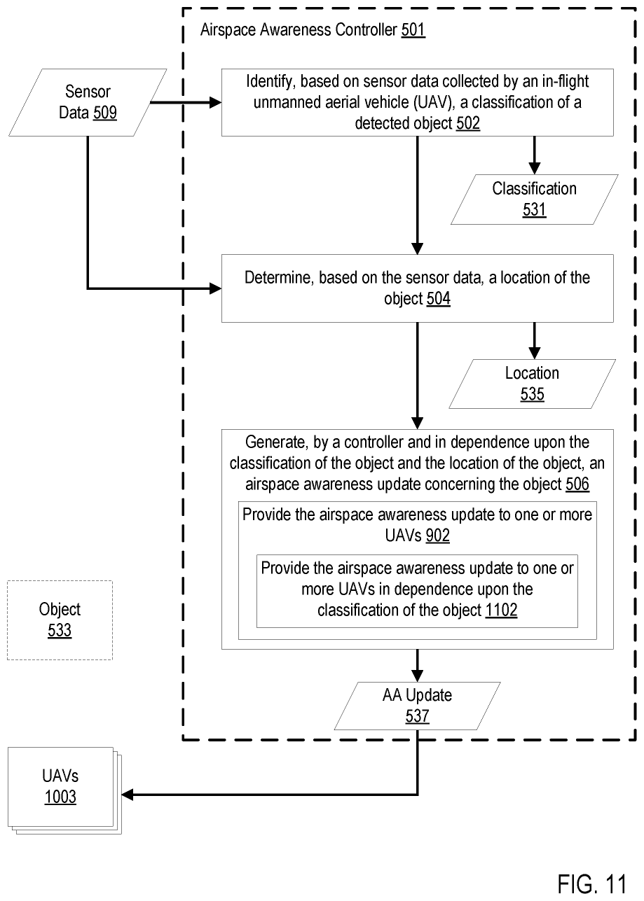

For further explanation, FIG. 11 sets forth a flow chart illustrating another example method for updating airspace awareness for unmanned aerial vehicles in accordance with some embodiments of the present disclosure. Like the method of FIG. 10, the example method of FIG. 11 also includes identifying 502, based on sensor data 509 collected by an in-flight unmanned aerial vehicle (UAV), a classification 531 of a detected object 533; determining 504, based on the sensor data 509, a location 535 of the object 533; and generating, by a controller and in dependence upon the classification 531 of the object and the location 535 of the object 533, an airspace awareness update 537 concerning the object 533, including providing 1002 the airspace awareness update 537 to one or more UAVs 1003.

In the example method of FIG. 11, providing 1002 the airspace awareness update 537 to one or more UAVs 1003 includes providing 1102 the airspace awareness update to one or more UAVs in dependence upon at least the classification 531 of the object 533. In some examples, providing 1102 the airspace awareness update to one or more UAVs in dependence upon at least the classification 531 of the object 533 may be carried out by the airspace awareness controller 501 of a ground-based station (e.g., a control device or server) providing an airspace awareness update 537 generated from sensor data collected by one UAV to one or more other UAVs 1003 based on the classification 531 of the object 533. In some examples, the airspace awareness update 537 is provided further in dependence upon the location of the one or more UAVs 1003. For example, where a ground-based airspace awareness controller 501 receives an update 537 from one UAV indicating that a construction crane has been erected at a particular location, that update 537 may be provided by the ground-based airspace awareness controller 501 to another UAV that is presently near that particular location. In some examples, the airspace awareness update 537 is provided further in dependence upon a mission of the one or more UAVs 1003. For example, where a ground-based airspace awareness controller 501 receives an update 537 from one UAV indicating that a green sedan has been identified at a particular location, that update 537 may be provided by the ground-based airspace awareness controller 501 to another UAV that is tasked with the mission of locating a green sedan. The update 537 may also be provided to the one or more UAVs based on both the location of the UAV and the mission of the UAV. For example, if a reconnaissance UAV identifies a person in a lake, that update 537 may be provided by the ground-based airspace awareness controller 501 to the nearest rescue UAV that is tasked with rescuing drowning persons.

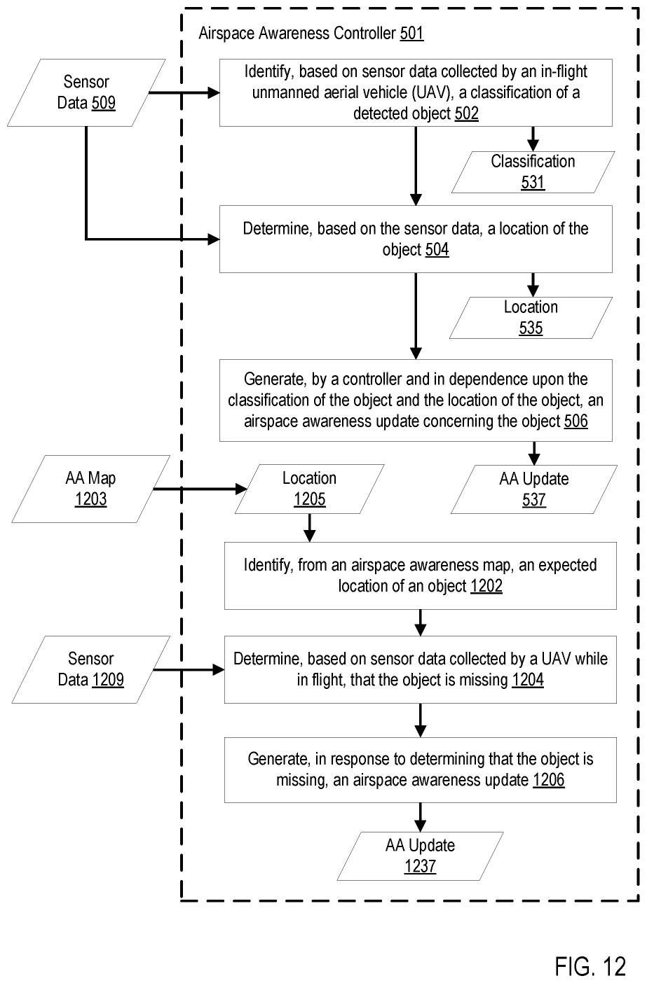

For further explanation, FIG. 12 sets forth a flow chart illustrating another example method for updating airspace awareness for unmanned aerial vehicles in accordance with some embodiments of the present disclosure. Like the method of FIG. 5, the example method of FIG. 12 also includes identifying 502, based on sensor data 509 collected by an in-flight unmanned aerial vehicle (UAV), a classification 531 of a detected object 533; determining 504, based on the sensor data 509, a location 535 of the object 533; and generating, by a controller and in dependence upon the classification 531 of the object and the location 535 of the object 533, an airspace awareness update 537 concerning the object 533.

The example method of FIG. 12 includes identifying 1202, from an airspace awareness map 1203, an expected location 1205 of an object. In some examples, identifying 1202, from an airspace awareness map 1203, an expected location 1205 of an object may be carried out by the airspace awareness controller 501 identifying that an object is in proximity to a UAV based on the location 1205 of the object on the airspace awareness map 1203. For example, in proximity may be defined as within a sensor range, within a predefined distance, or by some other measure. Consider an example where the airspace awareness map 1203 indicates that an object having the tag ‘construction crane’ is located at location X.

The example method of FIG. 12 also includes determining 1204, based on sensor data 1209 collected by a UAV while in flight, that the object is missing. In some examples, determining 1204, based on sensor data 1209 collected by a UAV while in flight, that the object is missing is carried out by the airspace awareness controller 501 detecting that no object is present at the location 1205 based on the sensor data 1209. For example, when the UAV comes within proximity of the expected location 1205 of the object, sensor data 1209 (e.g., LIDAR or SONAR data) may indicate that no object is detected at the location 1205. Continuing the above example, consider that the structure corresponding to the ‘construction crane’ is not present at location X, for example, because the construction crane has been removed.

The example method of FIG. 12 also includes generating 1206, in response to determining that the object is missing, an airspace awareness update 1237. In some examples, generating 1206, in response to determining that the object is missing, an airspace awareness update 1237 is carried out by the airspace awareness controller 501 generating an update 1237 that indicates the object should be deleted from the airspace awareness map 1203. For example, where the object has a unique identifier in the airspace awareness map 1203, generating 1206 the airspace awareness update 1237 may be carried out by deleting or sending an instruction to delete an entry corresponding to the unique identifier from an airspace awareness map database. As another example, generating 1206 the airspace awareness update 1237 may be carried out by generating an update that includes the expected location 1205 and a NULL object tag. As yet another example, generating 1206 the airspace awareness update 1237 may be carried out by generating an update that includes the object tag and location 1205 for the object extracted from the airspace awareness map 1203 and a special instruction or label indicating the object is no longer present. Continuing the above example, the airspace awareness controller 501 may generate an airspace awareness update 1237 that indicates the ‘construction crane’ object at location X should be removed from the airspace awareness map 1203.

In a particular implementation, airspace awareness updates are exchanged using a blockchain data structure as described above. The blockchain data structure may be shared in a distributed manner across a plurality of devices of in a UAV network, such as the UAV 102, the control device 120, and the server 140 in FIG. 1. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple of the devices of the system 100 in a manner that maintains security of the shared blockchain data structure as a public (i.e., available to other devices) and incorruptible (or tamper evident) ledger. Alternatively, as in FIG. 1, the blockchain data structure is stored in a distributed manner in the distributed computing network 151.

Readers will appreciate that, although a single airspace awareness controller is depicted in FIGS. 5-12, the steps in the example methods of FIGS. 5-12 may be performed in concert by multiple airspace awareness controllers distributed across multiple devices. For example and not limitation, an airspace awareness controller on a UAV may identify the location of the object whereas an airspace awareness controller on a ground-based device (e.g., the control device or the server) may identify the classification of the object based on sensor data provided by the UAV and generate the airspace awareness update based on based on the identified location provided by the UAV.

Exemplary embodiments of the present invention are described largely in the context of a fully functional computer system for updating airspace awareness for unmanned aerial vehicles. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method of updating airspace awareness for unmanned aerial vehicles, the method comprising: identifying, based on sensor data collected by an in-flight unmanned aerial vehicle (UAV), a classification of a detected object; determining, based on the sensor data, a location of the object; and generating, by a controller and in dependence upon the classification of the object and the location of the object, an airspace awareness update concerning the object.

2. The method of statement 1 wherein the airspace awareness update modifies an airspace awareness map.

3. The method of any of statements 1-2 further comprising: determining whether an airspace awareness map includes the object; and wherein generating, by a controller and in dependence upon the classification of the object and the location of the object, an airspace awareness update concerning the object includes generating the airspace awareness update in response to determining that the airspace awareness map omits the object.

4. The method of any of statements 1-3 wherein identifying, based on sensor data collected by an in-flight unmanned aerial vehicle (UAV), a classification of a detected object includes identifying the classification of the detected object in dependence upon the sensor data and one or more object models.

5. The method of any of statements 1-4 wherein generating, by a controller and in dependence upon the classification of the object and the location of the object, an airspace awareness update concerning the object includes populating the object on an airspace awareness map.

6. The method any of statements 1-5 wherein generating, by a controller and in dependence upon the classification of the object and the location of the object, an airspace awareness update concerning the object includes providing the airspace awareness update to a central repository.

7. The method of any of statements 1-6 wherein generating, by a controller and in dependence upon the classification of the object and the location of the object, an airspace awareness update concerning the object includes providing the airspace awareness update to one or more UAVs.

8. The method of any of statements 1-7, wherein providing the airspace awareness update to one or more UAVs includes providing the airspace awareness update to one or more UAVs in dependence upon the classification of the object.

9. The method of any of statements 1-8 further comprising: identifying, from an airspace awareness map, an expected location of an object; determining, based on sensor data collected by a UAV while in flight, that the object is missing; and generating, in response to determining that the object is missing, an airspace awareness update.

10. An apparatus for updating airspace awareness for unmanned aerial vehicles, the apparatus comprising: a processor; and a memory storing instructions that when executed by the processor cause the apparatus to carry out operations of: identifying, based on sensor data collected by an in-flight unmanned aerial vehicle (UAV), a classification of a detected object; determining, based on the sensor data, a location of the object; and generating, by a controller and in dependence upon the classification of the object and the location of the object, an airspace awareness update concerning the object.

11. The apparatus of statement 10 wherein the airspace awareness update modifies an airspace awareness map.

12. The apparatus of any of statements 10-11 further comprising instructions that when executed by the processor cause the apparatus to carry out operations of: determining whether an airspace awareness map includes the object; and wherein generating, by a controller and in dependence upon the classification of the object and the location of the object, an airspace awareness update concerning the object includes generating the airspace awareness update in response to determining that the airspace awareness map omits the object.

13. The apparatus of any of statements 10-12 wherein identifying, based on sensor data collected by an in-flight unmanned aerial vehicle (UAV), a classification of a detected object includes identifying the classification of the detected object in dependence upon the sensor data and one or more object models.

14. The apparatus of any of statements 10-13 wherein generating, by a controller and in dependence upon the classification of the object and the location of the object, an airspace awareness update concerning the object includes populating the object on an airspace awareness map.

15. The apparatus of any of statements 10-14 wherein generating, by a controller and in dependence upon the classification of the object and the location of the object, an airspace awareness update concerning the object includes providing the airspace awareness update to a central repository.

16. The apparatus of any of statements 10-15 wherein generating, by a controller and in dependence upon the classification of the object and the location of the object, an airspace awareness update concerning the object includes providing the airspace awareness update to one or more UAVs.

17. The apparatus of any of statements 10-16, wherein providing the airspace awareness update to one or more UAVs includes providing the airspace awareness update to one or more UAVs in dependence upon the classification of the object.

18. The apparatus of any of statements 10-17 further comprising instructions that when executed by the processor cause the apparatus to carry out operations of: identifying, from an airspace awareness map, an expected location of an object; determining, based on sensor data collected by a UAV while in flight, that the object is missing; and generating, in response to determining that the object is missing, an airspace awareness update.

19. A computer program product for updating airspace awareness for unmanned aerial vehicles, the computer program product disposed upon a non-transitory computer readable medium, the computer program product comprising computer program instructions that, when executed, cause a computer to carry out the operations of: identifying, based on sensor data collected by an in-flight unmanned aerial vehicle (UAV), a classification of a detected object; determining, based on the sensor data, a location of the object; and generating, by a controller and in dependence upon the classification of the object and the location of the object, an airspace awareness update concerning the object.

20. The computer program product of statement 19, wherein generating, by a controller and in dependence upon the classification of the object and the location of the object, an airspace awareness update concerning the object includes populating the object on an airspace awareness map.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of updating airspace awareness for unmanned aerial vehicles, the method comprising:
identifying, based on sensor data collected by an in-flight unmanned aerial vehicle (UAV), a classification of a detected object;
determining, based on the sensor data, a location of the object; and
generating, by a controller and in dependence upon the classification of the object and the location of the object, an airspace awareness update concerning the object.

2. The method of claim 1 wherein the airspace awareness update modifies an airspace awareness map.

3. The method of claim 1 further comprising:
determining whether an airspace awareness map includes the object; and
wherein generating, by a controller and in dependence upon the classification of the object and the location of the object, an airspace awareness update concerning the object includes generating the airspace awareness update in response to determining that the airspace awareness map omits the object.

4. The method of claim 1 wherein identifying, based on sensor data collected by an in-flight unmanned aerial vehicle (UAV), a classification of a detected object includes identifying the classification of the detected object in dependence upon the sensor data and one or more object models.

5. The method of claim 1 wherein generating, by a controller and in dependence upon the classification of the object and the location of the object, an airspace awareness update concerning the object includes populating the object on an airspace awareness map.

6. The method of claim 1 wherein generating, by a controller and in dependence upon the classification of the object and the location of the object, an airspace awareness update concerning the object includes providing the airspace awareness update to a central repository.

7. The method of claim 1 wherein generating, by a controller and in dependence upon the classification of the object and the location of the object, an airspace awareness update concerning the object includes providing the airspace awareness update to one or more UAVs.

8. The method of claim 7, wherein providing the airspace awareness update to one or more UAVs includes providing the airspace awareness update to one or more UAVs in dependence upon the classification of the object.

9. The method of claim 1 further comprising:
identifying, from an airspace awareness map, an expected location of an object;
determining, based on sensor data collected by a UAV while in flight, that the object is missing; and
generating, in response to determining that the object is missing, an airspace awareness update.

10. An apparatus for updating airspace awareness for unmanned aerial vehicles, the apparatus comprising:
a processor; and
a memory storing instructions that when executed by the processor cause the apparatus to carry out operations of:
identifying, based on sensor data collected by an in-flight unmanned aerial vehicle (UAV), a classification of a detected object;
determining, based on the sensor data, a location of the object; and
generating, by a controller and in dependence upon the classification of the object and the location of the object, an airspace awareness update concerning the object.

11. The apparatus of claim 10 wherein the airspace awareness update modifies an airspace awareness map.

12. The apparatus of claim 10 further comprising instructions that when executed by the processor cause the apparatus to carry out operations of:
determining whether an airspace awareness map includes the object; and
wherein generating, by a controller and in dependence upon the classification of the object and the location of the object, an airspace awareness update concerning the object includes generating the airspace awareness update in response to determining that the airspace awareness map omits the object.

13. The apparatus of claim 10 wherein identifying, based on sensor data collected by an in-flight unmanned aerial vehicle (UAV), a classification of a detected object includes identifying the classification of the detected object in dependence upon the sensor data and one or more object models.

14. The apparatus of claim 10 wherein generating, by a controller and in dependence upon the classification of the object and the location of the object, an airspace awareness update concerning the object includes populating the object on an airspace awareness map.

15. The apparatus of claim 10 wherein generating, by a controller and in dependence upon the classification of the object and the location of the object, an airspace awareness update concerning the object includes providing the airspace awareness update to a central repository.

16. The apparatus of claim 10 wherein generating, by a controller and in dependence upon the classification of the object and the location of the object, an airspace awareness update concerning the object includes providing the airspace awareness update to one or more UAVs.

17. The apparatus of claim 16, wherein providing the airspace awareness update to one or more UAVs includes providing the airspace awareness update to one or more UAVs in dependence upon the classification of the object.

18. The apparatus of claim 10 further comprising instructions that when executed by the processor cause the apparatus to carry out operations of:
identifying, from an airspace awareness map, an expected location of an object;
determining, based on sensor data collected by a UAV while in flight, that the object is missing; and
generating, in response to determining that the object is missing, an airspace awareness update.

19. A computer program product for updating airspace awareness for unmanned aerial vehicles, the computer program product disposed upon a non-transitory computer readable medium, the computer program product comprising computer program instructions that, when executed, cause a computer to carry out the operations of:
identifying, based on sensor data collected by an in-flight unmanned aerial vehicle (UAV), a classification of a detected object;
determining, based on the sensor data, a location of the object; and
generating, by a controller and in dependence upon the classification of the object and the location of the object, an airspace awareness update concerning the object.

20. The computer program product of claim 19, wherein generating, by a controller and in dependence upon the classification of the object and the location of the object, an airspace awareness update concerning the object includes populating the object on an airspace awareness map.
